(19) United States
(12) Patent Application Publication
(10) Pub. No.: US 2024/0417112 A1
(43) Pub. Date: Dec. 19, 2024

(54) BATTERY-POWERED, TEMPERATURE-CONTROLLED DEVICES AND METHODS FOR TRANSPORT, STORAGE, AND EXPERIMENTATION IN MICRO-GRAVITY RESEARCH AND MANUFACTURING APPLICATIONS

(71) Applicant: AMBASSADOR ASSET MANAGEMENT LIMITED PARTNERSHIP, Mesa, AZ (US)

(72) Inventor: Alp Ilercil, Scottsdale, AZ (US)

(21) Appl. No.: 18/744,407

(22) Filed: Jun. 14, 2024

Related U.S. Application Data
(60) Provisional application No. 63/508,416, filed on Jun. 15, 2023.

(51) Int. Cl. B64G 1/50; B64G 1/42

(52) U.S. Cl. CPC B64G 1/50; B64G 1/425

(57) ABSTRACT

A method of controlling the temperature of temperature-sensitive goods in a micro-gravity environment for micro-gravity research or manufacturing applications includes storing the temperature-sensitive goods in a vessel of a temperature-controlled device and controlling one or more heating elements to maintain the vessel at a predetermined temperature while the temperature-controlled device is in a micro-gravity environment. The method also includes powering the temperature-controlled device using batteries for a majority of a time while the temperature-controlled device is being transported from a normal gravity environment to a space station in the micro-gravity environment.

### CROSS-REFERENCE TO RELATED APPLICATIONS

This application claims the benefit of and priority to U.S. Provisional Application No. 63/508,416, filed Jun. 15, 2023, the content of which is incorporated herein by reference in its entirety.

### TECHNICAL FIELD

This document relates generally to micro-gravity research and manufacturing, and more specifically to methods of controlling the temperature of temperature-sensitive goods in a micro-gravity environment for micro-gravity research or manufacturing applications. The document also relates to battery-powered, temperature-controlled devices for transport, storage, and experimentation in micro-gravity research and manufacturing applications.

### BACKGROUND

A variety of research and manufacturing projects are completed in a micro-gravity environment, such as on the International Space Station (ISS). There are instances where the lack of gravity may lead to a result that is not obtainable in a normal gravity environment. As part of these projects, it is often necessary to transport temperature-sensitive goods (such as scientific specimens) between a normal gravity environment (e.g., Earth) and the micro-gravity environment (e.g., the ISS).

Existing solutions for transporting the temperature-sensitive goods include both active (i.e., powered) and passive (i.e., non-powered) systems. The active systems include freezers, refrigerators, and incubators. The passive systems include highly insulated stowage bags (e.g., Coldbags) that are temperature-controlled using phase change materials (e.g., Ice Bricks). These solutions, however, are not ideal because they lack precision. Moreover, the active systems require power from a space capsule that is conveying the temperature-sensitive goods to the micro-gravity destination. In addition, the existing solutions are bulky, and the amount of space on a space capsule and a space station is limited.

### SUMMARY

Some embodiments provide a method of controlling the temperature of temperature-sensitive goods in a micro-gravity environment for micro-gravity research or manufacturing applications. In some embodiments, the method includes storing the temperature-sensitive goods in a vessel of a temperature-controlled device, controlling one or more heating elements to maintain the vessel at a predetermined temperature while the temperature-controlled device is in a micro-gravity environment, and powering the temperature-controlled device using batteries for a majority of a time while the temperature-controlled device is being transported from a normal gravity environment to a space station in the micro-gravity environment.

In some embodiments, the temperature-controlled device is powered using batteries for an entirety of the time while the temperature-controlled device is being transported from the normal gravity environment to the space station in the micro-gravity environment. In some embodiments, the predetermined temperature is in the range of 0° C. to 42° C. In some embodiments, the predetermined temperature is 37° C. In some embodiments, the one or more heating elements include a thermoelectric device. In some embodiments, the one or more heating elements include a resistive heater. In some embodiments, the temperature-controlled device is powered using batteries continuously for a period of six to nine days. In some embodiments, the method also includes charging the batteries at the space station. In some embodiments, the method also includes powering the temperature-controlled device using the batteries for a majority of a time while the temperature-controlled device is being transported from the space station in the micro-gravity environment to the normal gravity environment. In some embodiments, the method also includes performing experiments using the temperature-sensitive goods in the micro-gravity environment.

Some embodiments provide a method of transporting temperature-sensitive goods in a micro-gravity environment for micro-gravity research or manufacturing applications. In some embodiments, the method includes placing the temperature-sensitive goods in a vessel of a temperature-controlled device under normal gravity conditions. In some embodiments, the temperature-controlled device is configured to maintain the vessel at a predetermined temperature. In some embodiments, the method includes loading the temperature-controlled device into a space capsule and transporting the temperature-sensitive goods to a micro-gravity environment using the space capsule. In some embodiments, the temperature-controlled device is battery-powered for a majority of a time spent transporting in the space capsule.

In some embodiments, the micro-gravity environment is outer space, and a destination of the space capsule is a space station. In some embodiments, the method also includes charging batteries of the temperature-controlled device at the space station. In some embodiments, the method also includes transporting the temperature-controlled device from the space station to a normal gravity environment. In some embodiments, the temperature-controlled device is battery-powered for a majority of the transport time to the normal gravity environment. In some embodiments, the temperature-controlled device is configured to be battery-powered for a continuous time period of at least six days. In some embodiments, the temperature-controlled device is configured to be battery-powered for a continuous time period of at least nine days. In some embodiments, the method also includes storing the temperature-sensitive goods in the temperature-controlled device in the micro-gravity environment after the transporting is complete. In some embodiments, the method also includes performing experiments using the temperature-sensitive goods in the micro-gravity environment after the transporting is complete. In some embodiments, the predetermined temperature is in the range of 0° C. to 42° C.

Some embodiments provide a temperature-controlled transport and storage device for temperature-sensitive goods in a micro-gravity environment for micro-gravity research or manufacturing applications. In some embodiments, the device includes a housing, a vessel disposed within the housing and configured to contain the temperature-sensitive goods, one or more heating elements disposed within the housing and coupled to the vessel, a controller disposed within the housing and configured to operate the one or more heating elements to maintain the vessel at a predetermined temperature while the temperature-controlled device is in a micro-gravity environment, and a plurality of batteries configured to power the controller and the one or more heating elements for a majority of a time while the temperature-controlled device is being transported from a normal gravity environment to a space station in the micro-gravity environment.

In some embodiments, the housing includes a first section and a second section. In some embodiments, the vessel and the one or more heating elements are disposed in the first section. In some embodiments, the controller and the plurality of batteries are disposed in the second section. In some embodiments, the plurality of batteries is configured to power the controller and the one or more heating elements continuously for a period of at least six to nine days. In some embodiments, the plurality of batteries is configured to power the controller and the one or more heating elements continuously for an entirety of the time while the temperature-controlled device is being transported from the normal gravity environment to the space station in the micro-gravity environment. In some embodiments, the predetermined temperature is in the range of 0° C. to 42° C. In some embodiments, the predetermined temperature is 37° C. In some embodiments, the one or more heating elements include a thermoelectric device. In some embodiments, the one or more heating elements include a resistive heater. In some embodiments, the plurality of batteries is configured to be charged at the space station. In some embodiments, the plurality of batteries is configured to power the controller and the one or more heating elements for a majority of a time while the temperature-controlled device is being transported from the space station in the micro-gravity environment to the normal gravity environment.

The foregoing and other aspects, features, and advantages will be apparent from the DESCRIPTION and DRAWINGS, and from the CLAIMS.

### BRIEF DESCRIPTION OF THE DRAWINGS

Implementations will hereinafter be described in conjunction with the appended and/or included DRAWINGS.

FIG. 1 shows a schematic of a normal gravity environment and a micro-gravity environment according to some embodiments.

FIG. 2 shows a flowchart of a method of controlling the temperature of temperature-sensitive goods in a micro-gravity environment for micro-gravity research or manufacturing applications according to some embodiments.

FIG. 3 shows a schematic illustration of a temperature-controlled device according to some embodiments.

FIG. 4 shows a schematic illustration of components of a temperature-controlled device according to some embodiments.

FIG. 5 shows a perspective view of a temperature-controlled device according to some embodiments.

FIG. 6 shows a perspective view of a temperature-controlled device according to some embodiments.

FIG. 7 shows a perspective view of a temperature-controlled device, including internal components thereof, according to some embodiments.

FIG. 8 shows a side view of a temperature-controlled device, including internal components thereof, according to some embodiments.

FIG. 9 shows an exploded view of a temperature-controlled device according to some embodiments.

FIG. 10 shows a bottom view of a temperature-controlled device according to some embodiments.

FIG. 11 shows a perspective view of an electronics module of a temperature-controlled device according to some embodiments.

FIG. 12 shows a perspective view of an electronics module of a temperature-controlled device according to some embodiments.

FIG. 13 shows a perspective view of a battery holder of an electronics module of a temperature-controlled device according to some embodiments.

FIG. 14 shows a perspective view of a configuration of batteries for a temperature-controlled device according to some embodiments.

FIG. 15 shows a top view of a configuration of batteries for a temperature-controlled device according to some embodiments.

FIG. 16 shows a perspective view of an internal portion of an electronics module of a temperature-controlled device according to some embodiments.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices, and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The present disclosure relates generally to micro-gravity research and manufacturing, and more specifically to methods of controlling the temperature of temperature-sensitive goods in a micro-gravity environment for micro-gravity research or manufacturing applications. The disclosure also relates to battery-powered, temperature-controlled devices for transport, storage, and experimentation in micro-gravity research and manufacturing applications.

A variety of research and manufacturing projects are completed in a micro-gravity environment, such as on the International Space Station (ISS). There are instances where the lack of gravity may lead to a result that is not obtainable in a normal gravity environment. As part of these projects, it is often necessary to transport temperature-sensitive goods (such as scientific specimens) between a normal gravity environment (e.g., Earth) and the micro-gravity environment (e.g., the ISS).

Existing solutions for transporting the temperature-sensitive goods include both active (i.e., powered) and passive (i.e., non-powered) systems. The active systems include freezers, refrigerators, and incubators. The passive systems include highly insulated stowage bags (e.g., Coldbags) that are temperature-controlled using phase change materials (e.g., Ice Bricks). These solutions, however, are not ideal because they lack precision. Moreover, the active systems require power from a space capsule that is conveying the temperature-sensitive goods to the micro-gravity destination. In addition, the existing solutions are bulky, and the amount of space on a space capsule and a space station is limited. Improved temperature-control devices and methods that can precisely control temperature for temperature-sensitive goods without using power from a space capsule and while minimizing space that is used during transport, storage, and experimentation are desirable.

The present disclosure describes an improved method of controlling the temperature of temperature-sensitive goods in a micro-gravity environment. In some embodiments, the temperature-sensitive goods are stored in a vessel of a temperature-controlled device, one or more heating elements are controlled to maintain the vessel at a predetermined temperature, and the temperature-controlled device is powered using batteries while being transported from a normal gravity environment, such as Earth, to a space station in a micro-gravity environment, such as space. The temperature-controlled device may be powered using batteries for a majority of time of transport to the space station. For example, the temperature-controlled device may be powered using batteries during the entire time of transport to the space station. A space capsule may be used for the transport to the space station.

In some embodiments, the temperature-controlled device may be used to store the temperature-sensitive goods while at the space station (or other destination in a micro-gravity environment). Thus, the space station does not need to have a separate device for storing the temperature-sensitive goods upon arrival, thus saving space at the space station. Instead, the temperature-controlled device is easily portable from a space capsule to the space station. The batteries may be charged while at the space station, allowing the device to continue to maintain the temperature for the temperature-sensitive goods during storage and/or for transport (of the same temperature-sensitive goods or different temperature-sensitive goods) back to a normal gravity environment.

In some embodiments, the temperature-controlled device may be used for performing experiments involving the temperature-sensitive goods while at the space station (or other destination in a micro-gravity environment). Thus, the space station does not need to have a separate device for performing experiments, again saving space at the space station. In some embodiments, in addition to controlling temperature, temperature-controlled device may be configured to control other parameters, such as humidity, pressure, etc. that are important for a particular experiment. Thus, the temperature-controlled device is versatile and provides a comprehensive solution that is capable of far more than existing transport systems.

Temperature-controlled devices may have a variety of configurations. In some embodiments, the temperature-controlled device may include a housing and a vessel within the housing that receives and holds the temperature-sensitive goods. One or more heating elements may be disposed within the housing and coupled to the vessel. A controller may also be disposed within the housing that controls the operation of the heating elements to maintain the vessel at a predetermined temperature. The temperature-controlled device may also include a plurality of batteries to power the controller and the heating elements, including during transport from earth to a space station (e.g., on a space capsule).

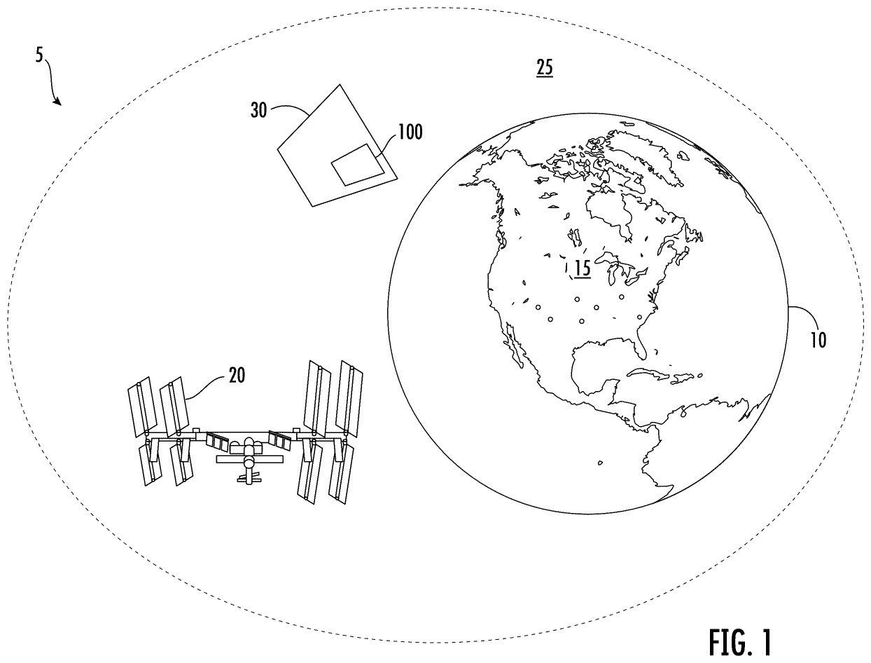

A schematic illustrating a general environment 5 for the methods disclosed herein is shown, for example, in FIG. 1. The general environment 5 includes a normal gravity environment 15 (such as Earth 10) and a micro-gravity environment 25 (such as outer space). It is often desirable to transport temperature-sensitive goods from Earth 10 to a destination in micro-gravity environment 25, such as space station 20. In some embodiments, space station 20 is the International Space Station. In some embodiments, space station 20 may be a particular country's or company's space station.

One or more space capsules 30 may travel between Earth 10 and space station 20. In some embodiments, a temperature-controlled device 100 containing the temperature-sensitive goods may be loaded onto space capsule 30 to be transported between Earth 10 (which is a normal gravity environment 15) and space station 20 (in a micro-gravity environment 25). In some embodiments, temperature-controlled device 100 is shippable and/or transportable.

The term “shippable” as used herein, refers to an object, such as the temperature-controlled device 100, that is conveyed as cargo in a hold of a vehicle such as a boat, ship, airplane, truck, space vehicle (such as a space capsule 30), orbiting space vehicle (such as space station 20), or other suitable vehicle. To be shippable, the temperature-controlled device 100 can be configured and designed to accommodate national shipping standards, international shipping standards, or both, and comply with parameters, requirements, and restrictions of the standards for movement of temperature-controlled device during shipping. In some embodiments, the temperature-controlled device 100 is completely self-contained, having its own power source and does not require recharging or an external power source during shipping (e.g., in space capsule 30 from Earth 10 to space station 20 or in space capsule 30 from space station 20 to Earth 10) in order to maintain the desired temperature parameters for the temperature-sensitive goods being shipped.

The term “transportable” as used herein, is a term that refers to an object, such as the temperature-controlled device 100, that is conveyed not typically as cargo in a commercial shipping sense, but can be moved or transported in a space vehicle (such as space capsule 30), in an orbiting space vehicle (such as space station 20), with a passenger in a vehicle such as a boat or ship, in an airplane as carry-on luggage, in a truck, van, or personal vehicle, including in a cab or passenger compartment with a driver. Thus, an object may be transportable because of its size, convenience, weight, and self-contained nature without being shippable because it does not meet applicable shipping regulations. Thus, a transportable temperature-controlled device 100 might be transportable without being shippable because of a failure to meet some shipping requirement. Alternatively, a temperature-controlled device 100 can be both transportable and shippable when it satisfies the relevant shipping requirements.

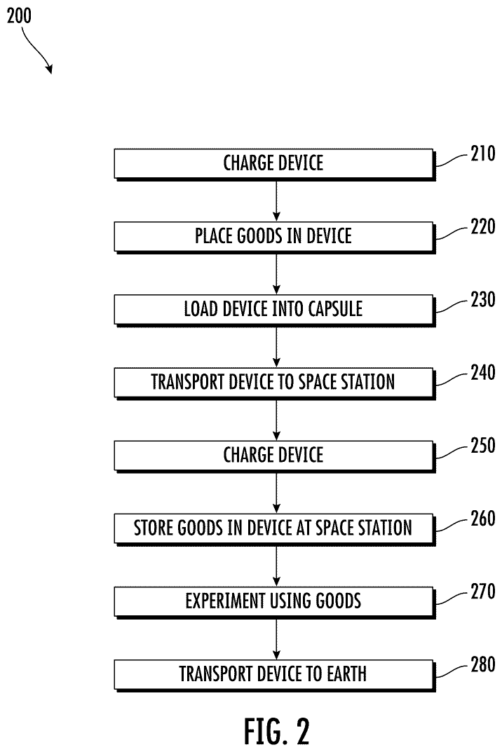

As noted above, a temperature-controlled device 100 may be configured to transport temperature-sensitive goods between Earth 10 and a micro-gravity environment 25, such as to or from space station 20. This may be done for micro-gravity research and/or manufacturing applications. A method 200 of transporting temperature-sensitive goods to and in a micro-gravity environment is shown, for example, in FIG. 2. Method 200 may include more or fewer operations than are shown in FIG. 2. Moreover, operations of method 200 may be performed in a different order than the order shown in FIG. 2 (whether expressly discussed below or not).

In some embodiments, a temperature-controlled device 100 is charged at operation 210. In some embodiments, charging temperature-controlled device 100 comprises plugging a charger into a port of temperature-controlled device 100 to charge or recharge batteries disposed within temperature-controlled device 100. In some embodiments, charging temperature-controlled device 100 comprises replacing one or more batteries of temperature-controlled device 100. Operation 210 may be omitted (for example, if batteries of temperature-controlled device 100 are already fully charged). In addition, although operation 210 is discussed first, operation 210 may be completed after the other operations (such as after placing temperature-sensitive goods in temperature-controlled device 100 or after temperature-controlled device 100 is loaded into a space capsule 30).

In some embodiments, temperature-sensitive goods are placed in temperature-controlled device 100 at operation 220. For example, the temperature-sensitive goods may be placed in a vessel of a temperature-controlled device 100 under normal gravity conditions. The temperature-sensitive goods may be any temperature-sensitive and/or perishable goods, including biological materials and samples, such as cell and tissue cultures, nucleic acids, bodily fluids, tissues, organs, embryos, plant tissues, and other sensitive goods such as pharmaceuticals, vaccines, and chemicals.

As soon as the temperature-sensitive goods are placed in temperature-controlled device 100, the temperature-sensitive goods may be considered to be stored in temperature-controlled device 100 (e.g., stored in a vessel of temperature-controlled device 100). While the temperature-sensitive goods are stored in a vessel of temperature-controlled device 100 (whether during transport or not), one or more heating elements may be controlled to maintain the vessel at a predetermined temperature. The predetermined temperature may be a temperature in the range of 0° C. to 42° C. For example, the predetermined temperature may be between 30° C. and 40° C. In some embodiments, the predetermined temperature is between 36° C. and 37.5° C. For example, the predetermined temperature may be 37° C.

In some embodiments, temperature-controlled device 100 is loaded into space capsule 30 at operation 230. The order of operations 210, 220, and 230 may be done in any order. For example, temperature-controlled device 100 may be loaded into space capsule 30, then charged, followed by temperature-sensitive goods being placed therein.

In some embodiments, temperature-controlled device 100 is transported to a destination in a micro-gravity environment 25, such as space station 20, at operation 240. The transport at operation 240 may begin in a normal gravity environment 15 and conclude in a micro-gravity environment 25. In some embodiments, the heating element(s) are controlled to maintain the vessel of temperature-controlled device 100 at a predetermined temperature (such as the predetermined temperature discussed above) while the temperature-controlled device 100 is in a micro-gravity environment 25. In some embodiments, temperature-controlled device 100 is powered using batteries for a majority of a time while temperature-controlled device 100 is being transported from a normal gravity environment 15 to a space station 20 in the micro-gravity environment 25 (e.g., in a space capsule 30).

For example, temperature-controlled device 100 may be powered using batteries for an entirety of the time while the temperature-controlled device 100 is being transported from the normal gravity environment 15 to the space station 20 in the micro-gravity environment 25. This removes the need for temperature-controlled device 100 to be powered by space capsule 30 and for temperature-controlled device 100 to interface with space capsule 30. In some embodiments, temperature-controlled device 100 is powered using batteries continuously for a period of at least six days. For example, temperature-controlled device 100 may be powered using batteries continuously for six to nine days. In some embodiments, temperature-controlled device 100 is powered using batteries continuously for a period of at least nine days. In some embodiments, temperature-controlled device 100 is powered using batteries continuously for up to ten days. Once space capsule 30 arrives at space station 20, temperature-controlled device 100 may be unloaded from space capsule 30 onto space station 20.

In some embodiments, temperature-controlled device 100 is charged at operation 250. In some embodiments, charging temperature-controlled device 100 comprises plugging a charger into a port of temperature-controlled device 100 to charge or recharge batteries disposed within temperature-controlled device 100. Operation 250 may take place at space station 20. Temperature-controlled device 100 may be charged using a direct current (DC) power source on space station 20. This may lead to efficient charging because the power source and the batteries are both DC. In some embodiments, temperature-controlled device 100 may be fully charged after about ten hours. The DC power source on space station 20 may be a 28 Volt DC power source. For example, an on-orbit PS-28 inverter may be used to charge temperature-controlled device 100 at space station 20.

In some embodiments, at operation 260, temperature-sensitive goods are stored in temperature-controlled device 100 at space station 20 after the transporting of operation 240 is complete. The temperature-sensitive goods may be stored in temperature-controlled device 100 until they are needed for performing experiments and/or manufacturing. During this time, temperature-controlled device 100 may be powered using batteries of temperature-controlled device 100 and/or by being plugged into power of space station 20. Because temperature-controlled device 100 may be used both for transport and storage, space station 20 does not need an additional storage solution for temperature-sensitive goods, which may free up room on space station 20.

In some embodiments, at operation 270, experiments are performed using the temperature-sensitive goods in the micro-gravity environment 25 (e.g., at space station 20). In some embodiments, the temperature-sensitive goods are used for manufacturing applications instead of research applications. In some embodiments, the experiments may be performed in temperature-controlled device 100. For example, temperature-controlled device 100 may be configured to control other parameters in addition to temperature, such as humidity, pressure, gas levels, or other parameters that may be important for a particular experiment. Because temperature-controlled device 100 may also be used for performing the experiments (in addition to being used for transport and storage), space station 20 does not need an additional unit for performing experiments using temperature-sensitive goods, which may free up additional room on space station 20.

In some embodiments, at operation 280, temperature-controlled device 100 may be transported from space station 20 back to Earth 10. This may be done in the same space capsule 30 or a different space capsule. In some embodiments, temperature-controlled device 100 contains temperature-sensitive goods for the return trip. In some embodiments, temperature-controlled device 100 may be reprogrammed for the return trip. For example, a different predetermined temperature may be used for the return trip. Thus, temperature-controlled device 100 may be reprogrammable during a mission to space station 20 in the micro-gravity environment 25 and back to the normal gravity environment 15. This programming may be done for a transport portion of a mission, a storage portion of a mission, or an experiment portion of a mission. Temperature-controlled device 100 may be programmed to any temperature within a range (e.g., such as within a range of 0° C. to 42° C.). In some embodiments, temperature-controlled device 100 is powered using batteries for a majority of a time while temperature-controlled device 100 is being transported from space station 20 in the micro-gravity environment 25 to the normal gravity environment 15.

For example, temperature-controlled device 100 may be powered using batteries for an entirety of the time while the temperature-controlled device 100 is being transported from space station 20 in the micro-gravity environment 25 to the normal gravity environment 15. This removes the need for temperature-controlled device 100 to be powered by space capsule 30 and for temperature-controlled device 100 to interface with space capsule 30.

Thus, temperature-controlled device 100 is adapted to transport temperature-sensitive goods between Earth 10 and a micro-gravity environment 25 (e.g., space). Temperature-controlled device 100 may maintain the temperature of scientific experiments (or other temperature-sensitive goods) during all phases of spaceflight (including ascent, on-orbit, and descent). A space vehicle, such as space capsule 30, may be used to transport the temperature-controlled device 100. Although only a single space capsule 30 is discussed, temperature-controlled device 100 may be transported on more than one space vehicle, for example, being ferried to or from an orbiting space vehicle (e.g., a space station 20 such as the International Space Station or “ISS”) by being carried on a supply space vehicle. In some embodiments, temperature-controlled device 100 may be configured to log data during a mission (e.g., environmental data, internal temperature data, etc.). This data may be reviewed during or after a mission (for example, to confirm that the predetermined temperature was maintained during the mission and/or as part of experiments).

In some embodiments, the overall dimensions of the temperature-controlled device 100, can include a height that is less than or equal to about 10 inches (″), 12″, 9″, 9.9″ or 9.875″ so that the temperature-controlled device 100 can fit in a compartment in a space vehicle (e.g., space capsule 30), a space station 20 (e.g., the International Space Station), or another micro-gravity environment 25. In some embodiments, the overall dimensions of the temperature-controlled device 100, do not exceed approximately: 9.875″ (H)×17.125″ (W)×19.875″ (L); 25.07 cm (H)×43.48 cm (W)×50.48 cm (L); or another dimension of a receptacle, rack, or container on a space vehicle. In some embodiments, the dimensions of the temperature-controlled device 100 are sized and shaped to fit within compartments or racks operable to hold at least the following ISS or space vehicle compatible items: Double Coldbag; Coldbag; Cargo Transfer Bag; or other existing or yet to be developed micro-gravity storage compartments or removable housings. In certain embodiments, the dimensions of the temperature-controlled device 100 are sized and shaped to fit within ISS or space vehicle compatible compartments or racks, such as: EXPRESS Rack; EXPRESS Rack locker shell; Coldbag rack; Cargo Transfer Bag rack; or other existing or yet to be developed micro-gravity storage racks or compartments. Table 1 below provides examples of maximum dimensions and mass loading for various Cargo Transfer Bags (“CTB”) used on the ISS. The temperature-controlled device 100 may be sized and shaped to comply with one or more of these examples below in Table 1, but may also be sized and shaped to fit within dimensions for future cargo on a space vehicle.

TABLE 1

| CTB | | | |
|---|---|---|---|
| Type | Configuration | Maximum Dimensions | Maximum Mass Loading |
| Half | Internal Rack/Locker Stow | External Dimensions: | 30 lb. (13.62 kg) maximum cargo mass accommodation |
| | | 9.75″ × 16.75″ × 9.25″ | for general stowage applications. |
| | | Internal Dimensions: | 60 lb. (27.22 kg) maximum cargo mass accommodation |
| | | 9.5″ × 16.25″ × 9.0″ | if outer envelope of CTB is completely restrained on all |
| | | | sides by hard structure (e.g., vehicle provided locker). |
| Single | Internal Rack/Locker Stow | External Dimensions: | 60 lb. (27.22 kg) maximum cargo mass accommodation |
| | | 19.75″ × 16.75″ × 9.75″ | for general stowage applications. |
| | | Internal Dimensions: | 100 lb. (45.36 kg) maximum cargo mass accommodation if |
| | | 19.5″ × 16.25″ × 9.5″ | outer envelope of CTB is completely restrained on all |
| | | | sides by hard structure (e.g., vehicle provided locker). |
| Double | Internal Rack/Locker Stow | External Dimensions: | 120 lb. (54.48 kg) maximum cargo mass accommodation |
| | | 19.75″ × 16.75″ × 19.75″ | for general stowage applications. |
| | | Internal Dimensions: | 180 lb. (81.65 kg) maximum cargo mass accommodation |
| | | 19.0″ × 16.25″ × 18.5″ | if outer envelope of CTB is completely restrained on all |
| | | | sides by hard structure (e.g., vehicle provided locker). |
| Triple | Internal Rack/Locker Stow | External Dimensions: | 180 lb. (81.72 kg) maximum cargo mass accommodation |
| | | 29.5″ × 16.75″ × 19.75″ | for general stowage applications (regardless of CTB |
| | | Internal Dimensions: | packing/stowing method). |
| | | 28.5″ × 16.25″ × 18.5″ | |

In some embodiments, the temperature-controlled device 100 has an internal payload volume for carrying a payload of temperature-sensitive goods, where the internal payload volume is up to approximately: 13 liters, 20 liters, 10 liters, 50 liters, 8 liters, 15 liters, 5 liters, 30 liters, 2 liters, 25 liters, 1 liter, or 17 liters. For example, the internal payload volume may be up to between 1 liter and 50 liters. Other internal payload volumes may also be used (within this range or outside of it). In certain embodiments, the temperature-controlled device 100 together with the payload of temperature-sensitive goods has a mass that does not exceed approximately: 17.22 kg; 18 kg; 20 kg; 15 kg; 10 kg; 25 kg; 35 kg; 12 kg; 5 kg; or 2 kg. For example, the device with the goods may have a mass between 2 kg and 35 kg. The device with the goods may have a different mass (within this range or outside of it). In some embodiments, the payload of temperature-sensitive goods (excluding the mass of temperature-controlled device 100) has a mass that does not exceed approximately: 10 kg; 15 kg; 20 kg; 12 kg; 8 kg; 5 kg; 30 kg; 25 kg; 3 kg; or 1.5 kg. For example, the goods may have a mass between 1.5 kg and 30 kg. The goods may have a different mass (within this range or outside of it). In various embodiments the temperature-controlled device 100 together with the payload of temperature-sensitive goods has a mass that does not exceed approximately 66%, 50%, or 33% of the maximum allowed mass for a standardized shape and mass (e.g., CTB dimensions and maximum mass examples shown in Table 1). In some embodiments, the temperature-controlled device 100 meets interface requirements from the Pressurized Payloads Interface Requirements Document SSP 57000 Rev R.

In some embodiments, temperature-controlled device 100 maintains the payload of temperature-sensitive goods at a temperature range of approximately: 36.0° C. to 37.5° C.; 36° C. to 38° C.; 96.8° F. to 99.5° F.; 34° C. to 40° C.; or at an optimal body temperature of a human or animal ±4° C. In some embodiments, temperature-controlled device 100 maintains the payload of temperature-sensitive goods at a temperature (or temperature range) within the range of approximately: −40° C. to 40° C.; 0° C. to 50° C.; or −25° C. to 45° C. In some embodiments, temperature-controlled device 100 maintains the payload of temperature-sensitive goods at or within a targeted temperature range for at least approximately: 240 hours, 10 days, 15 days, 12 days, 300 hours, 200 hours, or 100 hours.

In some embodiments, the battery of the temperature-controlled device 100 is configured to be the only source of power for the temperature-controlled device 100 during transportation to and/or from an orbiting space vehicle (e.g., space station 20, such as the ISS), but the battery may be recharged at the orbiting space vehicle by being connected to another power source (e.g., a solar powered energy system).

In some embodiments, the temperature-controlled device 100 is a battery-powered, temperature-controlled shipping device targeted to match existing Double Cold bag external dimensions, have a targeted internal volume of approximately 13 liters, and is capable of maintaining an internal temperature between 36.0° C. and 37.5° C. for up to ten (10) days on its own power source.

In some embodiments, prior to launch, the battery of the temperature-controlled device 100 will be charged at the processing site and programming of the temperature-controlled device 100 will be verified.

In some embodiments, the temperature-controlled device 100 will be delivered empty to the launch site. Loading of scientific experiments or other temperature-sensitive goods as payload into the temperature-controlled device 100 may be similar to the current method with existing Double Coldbag assets operated by NASA, ESA, and other space operators.

In some embodiments, the temperature-controlled device 100 is sized and shaped to be installed in an EXPRESS Rack locker shell, mounted within an EXPRESS Rack position, or as a typical Double Coldbag.

In some embodiments, prior to launch, the battery of temperature-controlled device 100 will be charged at the launch site. The temperature-controlled device 100 may be targeted to maintain an internal temperature between 36.0° C. and 37.5° C. for up to ten (10) days using the battery as the power source.

In some embodiments, the battery of the temperature-controlled device 100 can be charged via connection to a DC power source on the space station 20 (e.g., ISS (or another space vehicle)) and used for orbit-temperature storage.

In some embodiments, prior to descent, the battery of the temperature-controlled device 100 will be charged on the space station 20 (e.g., ISS (or another space vehicle)). The temperature-controlled device 100 may be targeted to maintain an internal temperature between 36.0° C. and 37.5° C. for up to ten (10) days on its own power source during descent.

In some embodiments, the temperature-controlled device 100 will be unloaded by Cold Stowage team at which time the device will be returned to the manufacturer or vendor for refurbishment or maintained by the Cold Stowage team for the next mission.

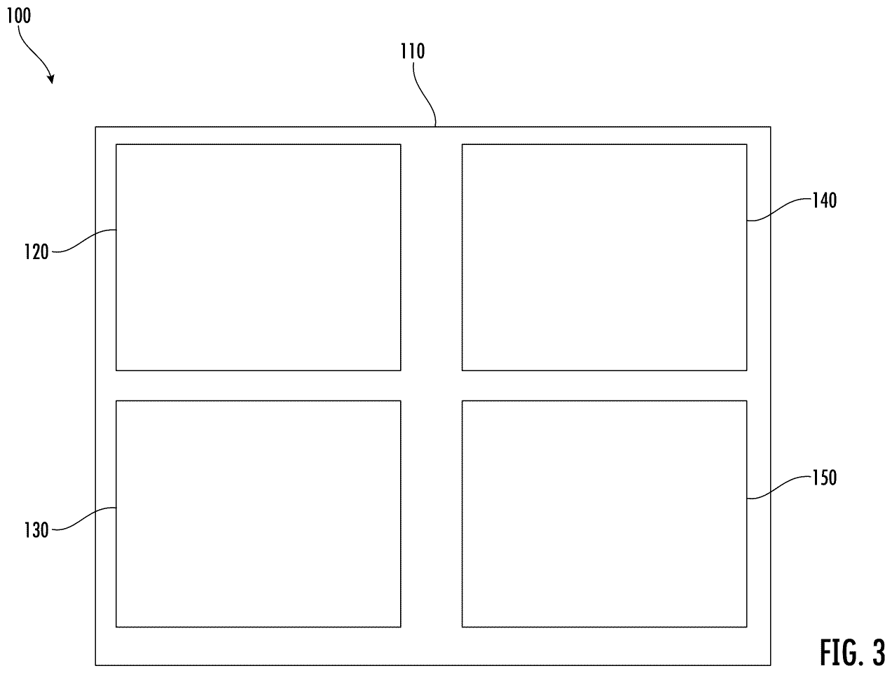

As noted above, temperature-controlled device 100 may take a variety of configurations. As shown schematically in FIG. 3, for example, temperature-controlled devices 100 may include a housing 110, a vessel 120, one or more heating elements 130, a controller 140, and one or more batteries 150. In some embodiments, housing 110 encloses the other components such that they are disposed within housing 110. Housing 110 may provide protection from an outside environment. In some embodiments, vessel 120 is configured to receive temperature-sensitive goods for transport, storage, and/or experimentation.

In some embodiments, heating element(s) 130 are configured to maintain the temperature of vessel 120 so that the temperature-sensitive goods disposed therein are maintained at a desired temperature. Heating element(s) 130 may be any type of heat pump or other heating device. In some embodiments, temperature-controlled device 100 may include a thermoelectric device for at least one of its heating element(s) 130. In some embodiments, temperature-controlled device 100 may include a resistive heater for at least one of its heating element(s) 130. Other heating devices may also be used. In some embodiments, a combination of different types of heating elements 130 may be used in a single temperature-controlled device 100.

In some embodiments, controller 140 is configured to operate the one or more heating elements 130 to maintain the vessel 120 at a predetermined temperature, such as while the temperature-controlled device 100 is in a micro-gravity environment 25, as discussed above. In some embodiments, batteries 150 are configured to power the controller 140 and the one or more heating elements 130. For example, batteries 150 may power temperature-controlled device 100 for a majority of a time while the temperature-controlled device 100 is being transported from a normal gravity environment 15 to a space station 20 in the micro-gravity environment 25, as discussed above.

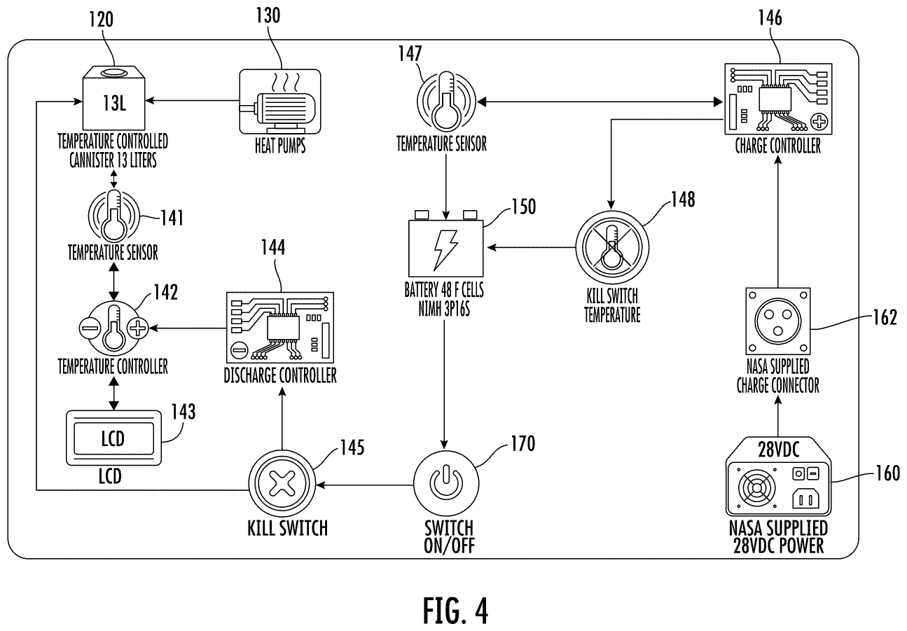

FIG. 4 shows another schematic of a temperature-controlled device 100. A representation of a vessel 120 is shown in the top left. Vessel 120 may be a temperature-controlled canister. In some embodiments, vessel 120 may be a 13-liter canister. One or more heat pump(s) 130 are coupled to vessel 120 and may operate to maintain the temperature of vessel 120. In some embodiments, heat pump(s) 130 are controlled using a discharge controller 144, a temperature sensor 141, and a temperature controller 142. Discharge controller 144 may control the amount of electricity from batteries 150 to send to heat pump(s) 130 so that the temperature of vessel 120 is maintained at a predetermined temperature. The predetermined temperature may be selected and/or adjusted using temperature controller 142. Temperature sensor 141 may be coupled to vessel 120 to provide feedback to temperature controller 142 on the current temperature. In some embodiments, a display 143 (e.g., an LCD) will show the current temperature of vessel 120, the predetermined temperature, or both. A kill switch 145 may also be included to shut down the operation of discharge controller 144 and thus heat pump(s) 130. In some embodiments, temperature-controlled device 100 includes a power switch 170, allowing a user to turn temperature-controlled device 100 on or off.

The right side of FIG. 4 illustrates charging aspects of temperature-controlled device 100. Batteries 150 may be provided as an on-board power source for operation of temperature-controlled device 100. Thus, temperature-controlled device 100 may be a battery-powered device. In some embodiments, batteries 150 comprise nickel metal hydride batteries. Batteries 150 may be F-type cells. Temperature-controlled device 100 may include between 10 and 80 batteries 150. For example, between 40 and 50 batteries 150 may be used. In some embodiments, 48 batteries 150 are used. As discussed above, in some embodiments, batteries 150 may power temperature-controlled device 100 for several days (e.g., up to ten days).

Batteries 150 may be charged when temperature-controlled device 100 is at space station 20. For example, a power source 160 may be used to charge batteries 150. Power source 160 may be a DC power source, such as a 28-volt DC power source. The power source 160 and a charge connector 162 may be supplied by the space station 20. In some embodiments, a charge controller 146 is configured to control the charging of batteries 150. For example, a temperature sensor 147 may be coupled to batteries 150 and in communication with charge controller 146. If a temperature of batteries 150 gets too hot during charging, charge controller 146 may activate a kill switch 148 to avoid overheating of batteries 150.

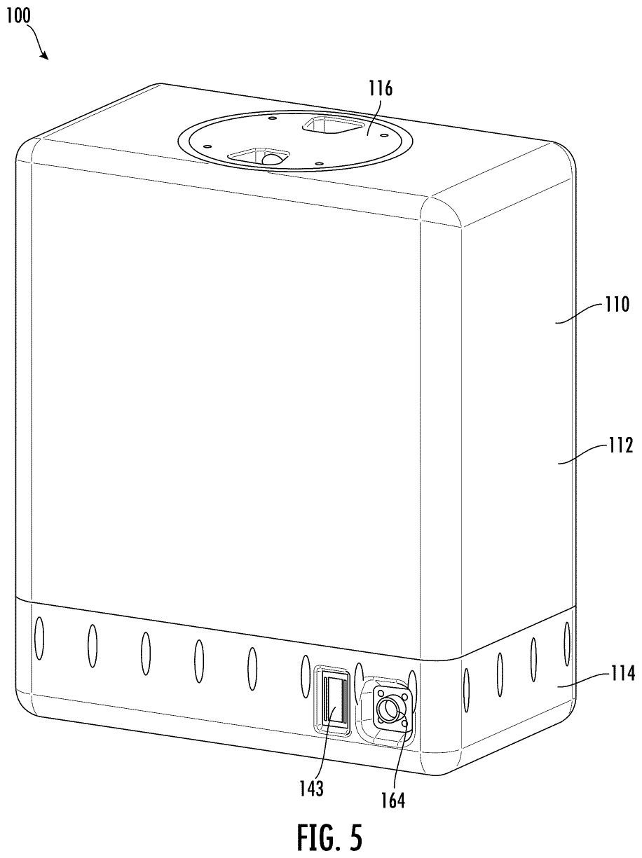

A temperature-controlled device 100 according to some embodiments is shown, for example, in FIGS. 5-9. In some embodiments, temperature-controlled device 100 comprises a housing 110. Housing 110 may be made of polyetherimide (such as ULTEM®), though other materials could also be used. In some embodiments, housing 110 is 3-D printed (e.g., using fused deposition modeling with polyetherimide as the material). Housing 110 may be made of two sections, including, a first section 112 and a second section 114.

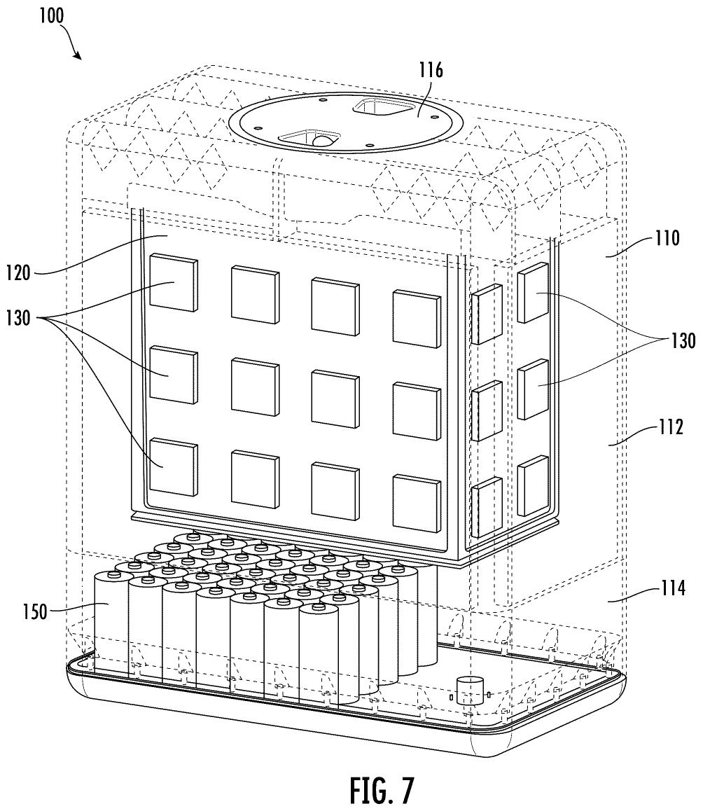

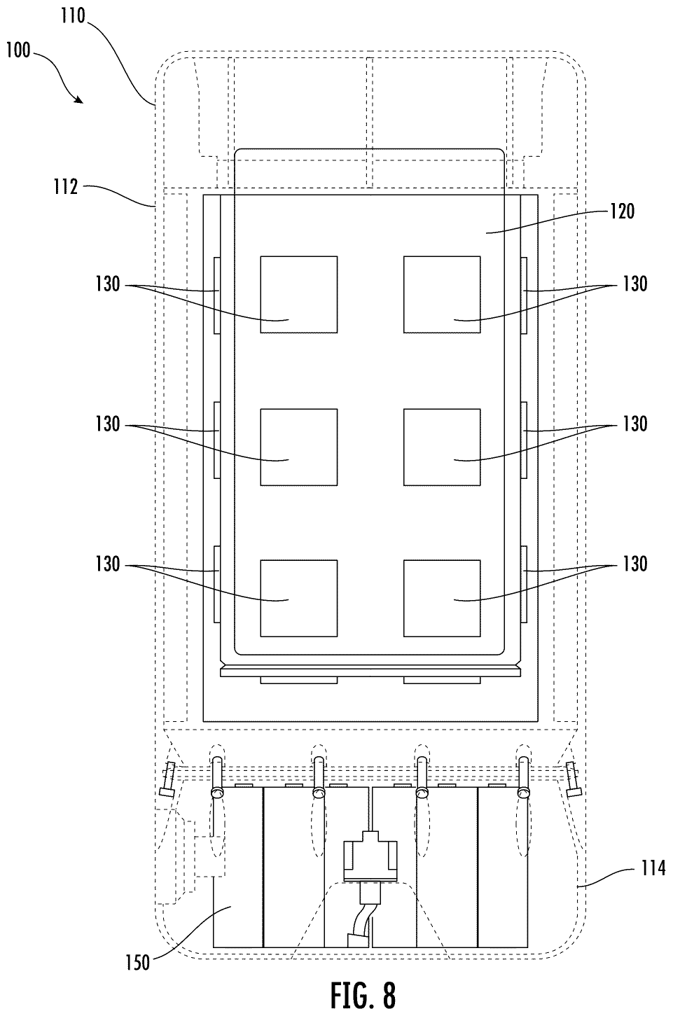

In some embodiments, vessel 120 and heating element(s) 130 are disposed in first section 112 (see FIGS. 7-8). In some embodiments, a space is provided in first section 112 for a lid 116. Lid 116 may be opened to allow access to an interior of vessel 120 (e.g., to place temperature-sensitive goods within vessel 120 or remove temperature-sensitive goods). Lid 116 may be closed to seal an interior of vessel 120 from an exterior environment, thus facilitating the temperature control discussed herein. In some embodiments, lid 116 may be coupled to first section 112 of housing 110 via a threaded connection, though other connections may also be used.

In some embodiments, controller 140 and batteries 150 are disposed in second section 114 (see FIGS. 7-9). Second section 114 may be considered an electronics module. A display screen 143 (such as an LCD) is disposed on second section 114. Display screen may show the current temperature of vessel 120 and/or the predetermined temperature at which temperature-controlled device 100 is set. In some embodiments, a charging port 164 is disposed on second section 114. Charging port 164 facilitates charging of batteries 150 (e.g., before transporting temperature-sensitive goods to space station 20, at space station 20, etc.). Charging port 164 may be configured to receive a charging connector/cord to connect temperature-controlled device 100 to an external power source (e.g., power source 160), thus facilitating charging of batteries 150 in temperature-controlled device 100.

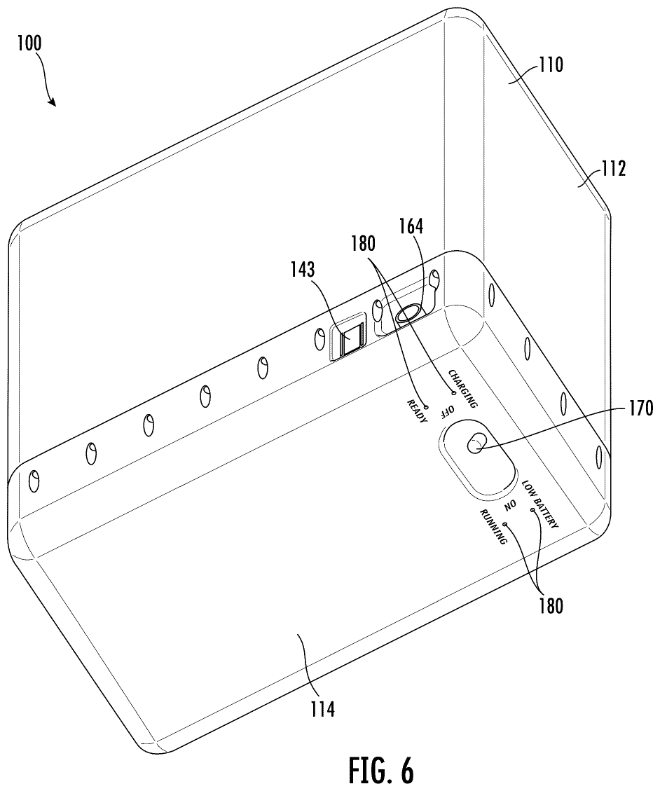

A power switch 170 may be disposed on section 114, as shown, for example, in FIG. 6. In some embodiments, power switch 170 may be disposed on a bottom of section 114 of housing 110. A plurality of indicators 180 (such as LEDs) may also be disposed on housing 110. For example, indicators 180 may be disposed adjacent to power switch 170. Indicators 180 may provide a variety of status information to a user. For example, there may be indicators 180 relating to charge controller 146 (see FIG. 4), such as an indicator 180 indicating that temperature-controlled device 100 is charging and/or an indicator 180 indicating that temperature-controlled device 100 is ready for use as shown in FIG. 6. As another example, there may be indicators 180 relating to discharge controller 144 (see FIG. 4), such as an indicator 180 indicating that temperature-controlled device 100 is currently running, and/or an indicator 180 indicating that temperature-controlled device 100 has a low battery as shown in FIG. 6. Other indicators 180 may also be used.

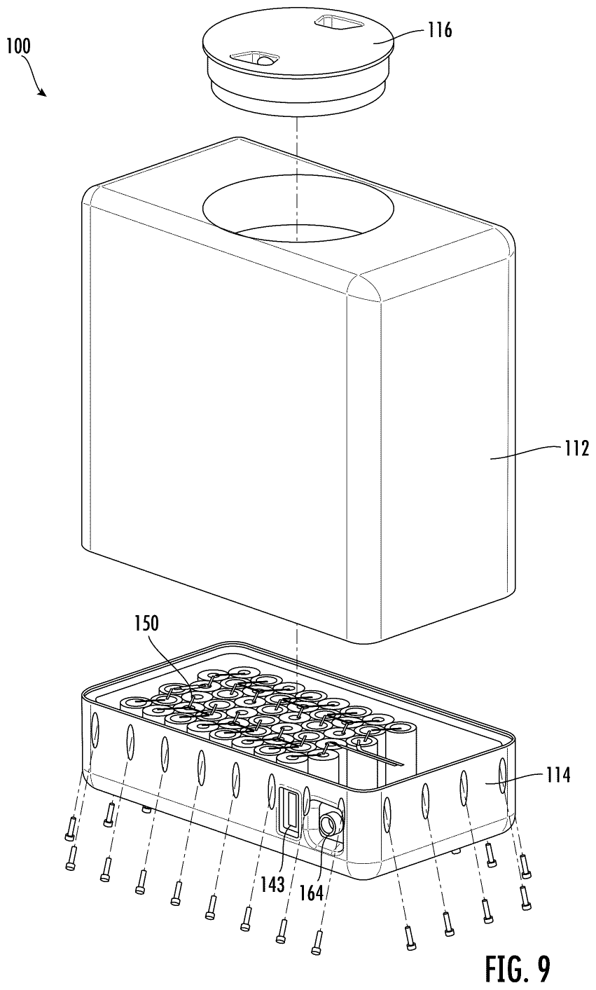

First section 112 and second section 114 may be coupled using a variety of connections, such as fasteners (bolts, screws, etc.), snap connections, and/or adhesive connections. FIG. 9, for example, shows a fastener connection between first section 112 and second section 114.

FIGS. 7 and 8 show housing 110 as being transparent to illustrate vessel 120, heating elements 130, batteries 150 within housing 110. In some embodiments, heating elements 130 may be disposed within housing 110 and coupled to vessel 120. For example, heating elements 130 may be coupled to one or more exterior surfaces of vessel 120. In some embodiments, temperature-controlled device 100 comprises between ten and eighty heating devices 130. For example, temperature-controlled device 100 may include between forty and fifty heating devices 130. In some embodiments, forty-eight heating devices 130 are used. Heating devices 130 may be electrically coupled in series and/or in parallel.

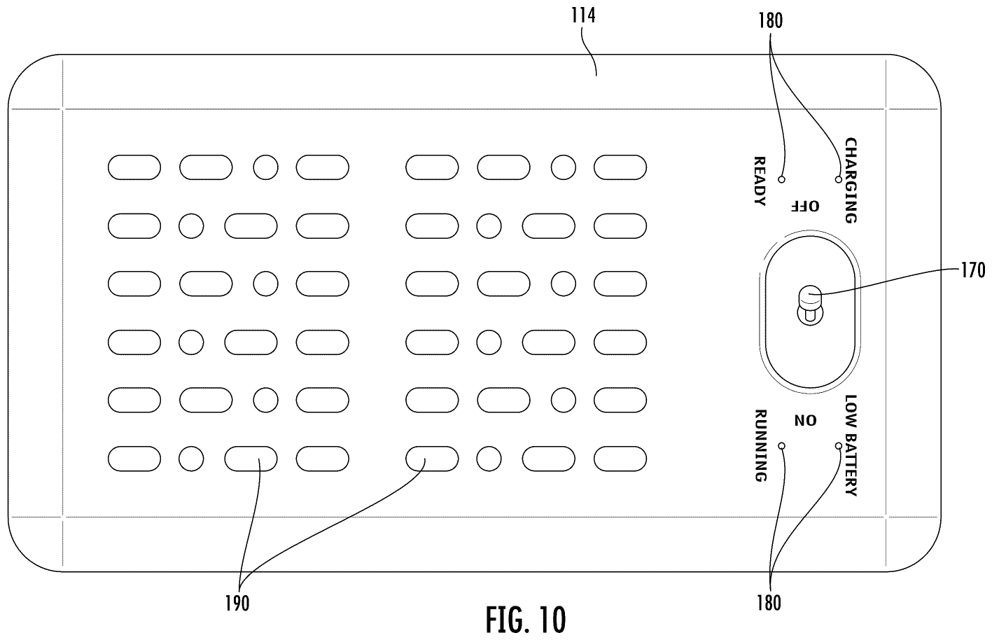

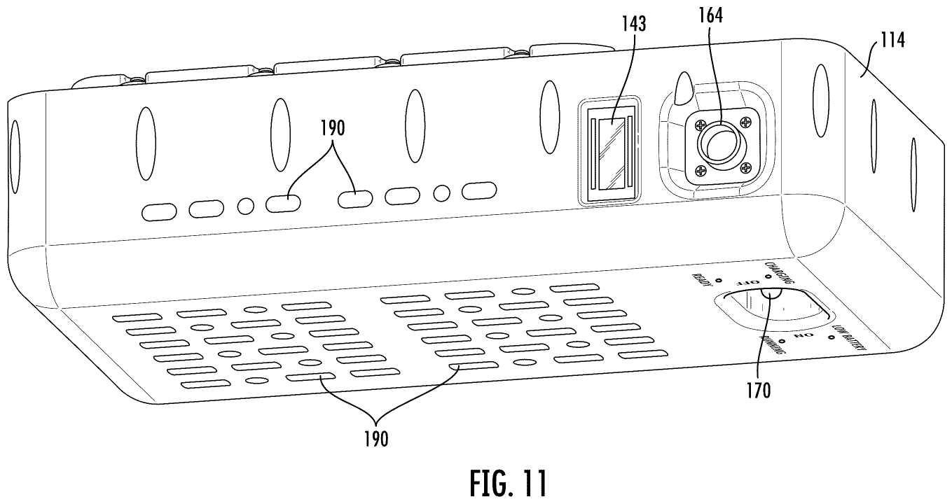

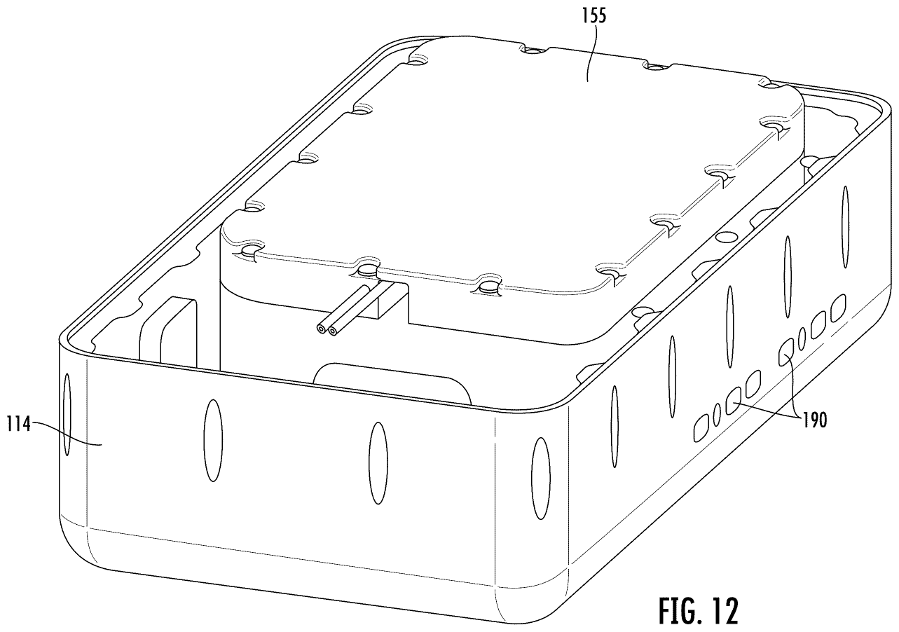

In some embodiments, as shown, for example, in FIGS. 10-12, second section 114 includes venting 190 for batteries 150 (e.g., to reduce overheating while batteries 150 are operating). For example, second section 114 may include a number of venting holes 190 on a bottom of second section 114 (see FIG. 10) and/or on a side of section 114 (see FIGS. 11-12).

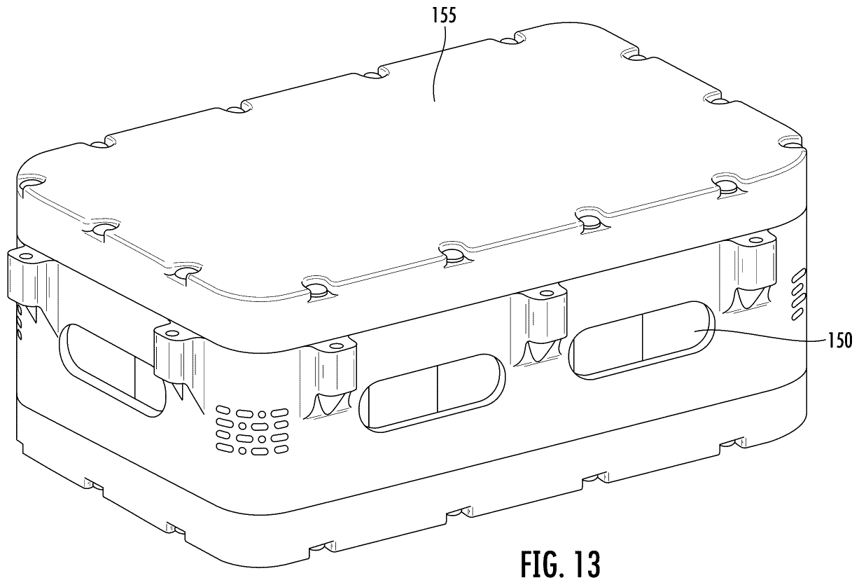

In some embodiments, batteries 150 are disposed within a battery holder 155, as shown, for example, in FIGS. 12-13. Battery holder 155 may be disposed within second section 114 of housing 110 (see FIG. 12). Battery holder 155 may be removable from second section 114, which may facilitate replacement of batteries 150 when needed.

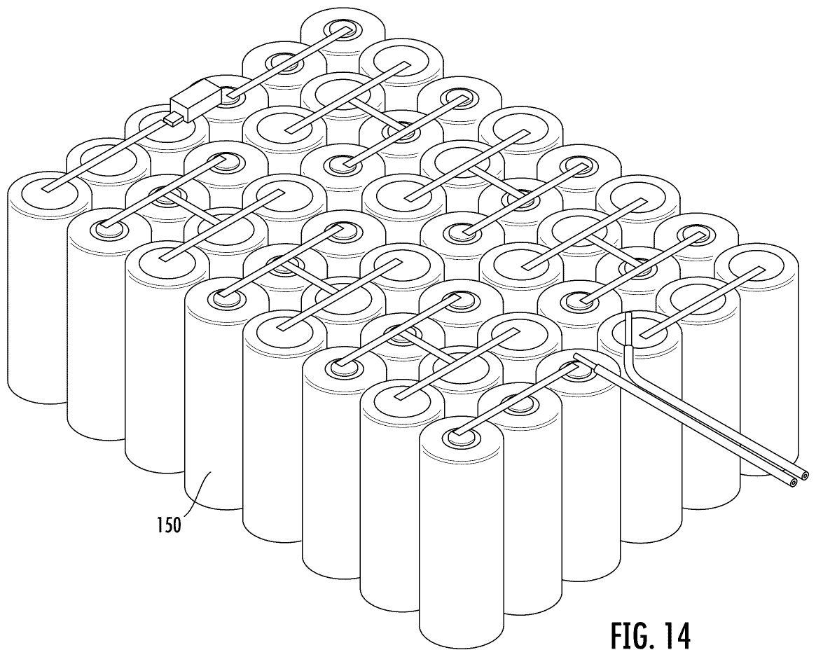

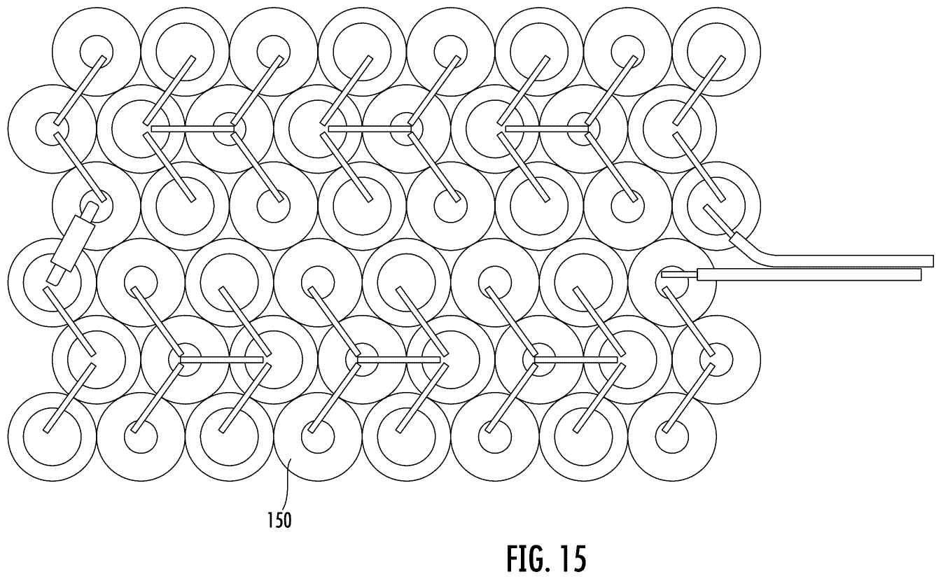

In some embodiments, batteries 150 may be arranged in a stacked configuration, as shown, for example, in FIG. 14. Although FIG. 14 shows 48 batteries 150, a different number of batteries 150 may be used. Batteries 150 may be electrically coupled with each other in parallel and series. For example, as shown in FIG. 14, groups of three batteries 150 are electrically coupled in parallel and each group is electrically coupled with the other groups in series. Other configurations are also possible. In some embodiments, batteries 150 may be arranged in a staggered configuration, as shown, for example, in FIG. 15. Batteries 150 may still be electrically coupled with each other in parallel and series. For example, as shown in FIG. 15, groups of three batteries 150 are electrically coupled in parallel and each group is electrically coupled with the other groups in series. Other configurations are also possible.

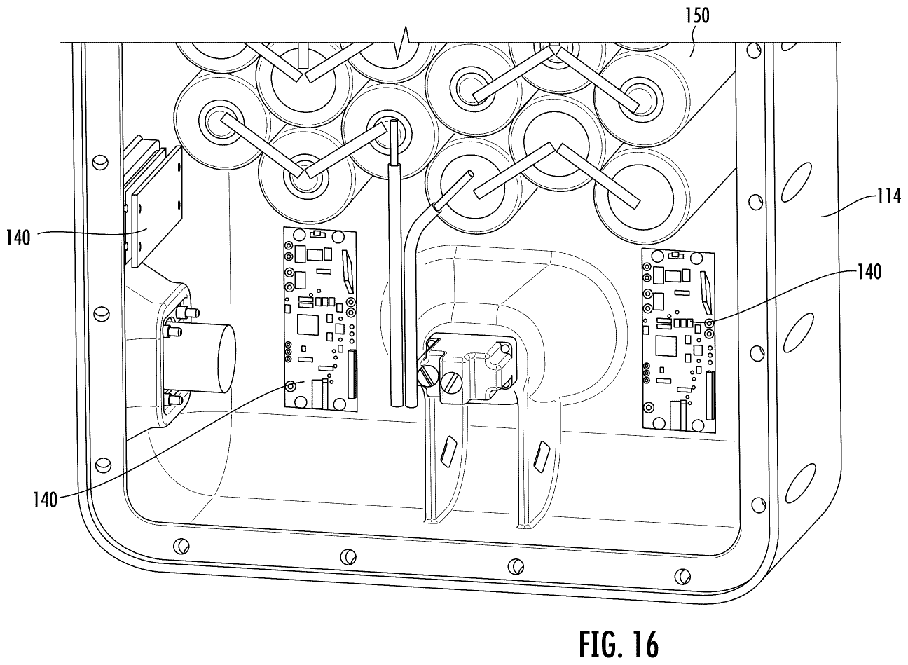

In some embodiments, controller 140 may be disposed within second section 114, as shown in FIG. 16. Controller 140 may include one or more printed circuit boards. Other control circuitry may be used for controller 140. In some embodiments, controller 140 includes discharge controller 144 and charge controller 146 (and their associated components) discussed with respect to FIG. 4.

The temperature-controlled device 100 described herein presents a number of advantages including a temperature-controlled device 100 comprising a weight of as little as about 7.5 lbs. that can provide up to ten days of operation on single battery charge to batteries 150, whereas units previously known in the art would be much bulkier and require connecting to power on space capsule 30. In addition, due to the versatility of temperature-controlled device 100 (e.g., transport, storage, experimentation), space-saving on space station 20 and/or space capsule 30 is possible.

Many additional implementations are possible. Further implementations are within the CLAIMS.

It will be understood that implementations of the battery-powered, temperature-controlled devices include but are not limited to the specific components disclosed herein, as virtually any components consistent with the intended operation of various battery-powered, temperature-controlled devices may be utilized. Accordingly, for example, it should be understood that, while the drawings and accompanying text show and describe particular implementations of battery-powered, temperature-controlled devices, any such implementation may comprise any shape, size, style, type, model, version, class, grade, measurement, concentration, material, weight, quantity, and/or the like consistent with the intended operation of battery-powered, temperature-controlled devices.

The concepts disclosed herein are not limited to the specific methods or battery-powered, temperature-controlled devices shown herein. For example, it is specifically contemplated that the components included in particular battery-powered, temperature-controlled devices may be formed of any of many different types of materials or combinations that can readily be formed into shaped objects and that are consistent with the intended operation of the battery-powered, temperature-controlled devices. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, battery-powered, temperature-controlled devices may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular implementations of battery-powered, temperature-controlled devices, it should be readily apparent that a number of modifications may be made without departing from the spirit thereof and that these implementations may be applied to other implementations disclosed or undisclosed. The presently disclosed methods and battery-powered, temperature-controlled devices are, therefore, to be considered in all respects as illustrative and not restrictive.

I claim:

1. A method of controlling the temperature of temperature-sensitive goods in a micro-gravity environment for micro-gravity research or manufacturing applications, the method comprising:
storing the temperature-sensitive goods in a vessel of a temperature-controlled device;
controlling one or more heating elements to maintain the vessel at a predetermined temperature while the temperature-controlled device is in a micro-gravity environment; and
powering the temperature-controlled device using batteries for a majority of a time while the temperature-controlled device is being transported from a normal gravity environment to a space station in the micro-gravity environment.

2. The method of claim 1, wherein the temperature-controlled device is powered using batteries for an entirety of the time while the temperature-controlled device is being transported from the normal gravity environment to the space station in the micro-gravity environment.

3. The method of claim 1, wherein the predetermined temperature is in the range of 0° C. to 42° C.

4. The method of claim 1, wherein the predetermined temperature is 37° C.

5. The method of claim 1, wherein the one or more heating elements comprise a thermoelectric device.

6. The method of claim 1, wherein the one or more heating elements comprise a resistive heater.

7. The method of claim 1, wherein the temperature-controlled device is powered using batteries continuously for a period of six to nine days.

8. The method of claim 1, further comprising charging the batteries at the space station.

9. The method of claim 1, further comprising powering the temperature-controlled device using the batteries for a majority of a time while the temperature-controlled device is being transported from the space station in the micro-gravity environment to the normal gravity environment.

10. The method of claim 1, further comprising performing experiments using the temperature-sensitive goods in the micro-gravity environment.

11. A method of transporting temperature-sensitive goods in a micro-gravity environment for micro-gravity research or manufacturing applications, the method comprising:
placing the temperature-sensitive goods in a vessel of a temperature-controlled device under normal gravity conditions, wherein the temperature-controlled device is configured to maintain the vessel at a predetermined temperature;
loading the temperature-controlled device into a space capsule; and
transporting the temperature-sensitive goods to a micro-gravity environment using the space capsule, wherein the temperature-controlled device is battery-powered for a majority of a time spent transporting in the space capsule.

12. The method of claim 11, wherein the micro-gravity environment is outer space, and wherein a destination of the space capsule is a space station.

13. The method of claim 12, further comprising charging batteries of the temperature-controlled device at the space station.

14. The method of claim 13, further comprising transporting the temperature-controlled device from the space station to a normal gravity environment, wherein the temperature-controlled device is battery-powered for a majority of the transport time to the normal gravity environment.

15. The method of claim 11, wherein the temperature-controlled device is configured to be battery-powered for a continuous time period of at least six days.

16. The method of claim 11, wherein the temperature-controlled device is configured to be battery-powered for a continuous time period of at least nine days.

17. The method of claim 11, further comprising storing the temperature-sensitive goods in the temperature-controlled device in the micro-gravity environment after the transporting is complete.

18. The method of claim 11, further comprising performing experiments using the temperature-sensitive goods in the micro-gravity environment after the transporting is complete.

19. The method of claim 11, wherein the predetermined temperature is in the range of 0° C. to 42° C.

20. A temperature-controlled transport and storage device for temperature-sensitive goods in a micro-gravity environment for micro-gravity research or manufacturing applications, the device comprising:
a housing;
a vessel disposed within the housing and configured to contain the temperature-sensitive goods;
one or more heating elements disposed within the housing and coupled to the vessel;
a controller disposed within the housing and configured to operate the one or more heating elements to maintain the vessel at a predetermined temperature while the temperature-controlled device is in a micro-gravity and environment;
a plurality of batteries configured to power the controller and the one or more heating elements for a majority of a time while the temperature-controlled device is being transported from a normal gravity environment to a space station in the micro-gravity environment.

21. The device of claim 20, wherein the housing comprises a first section and a second section, wherein the vessel and the one or more heating elements are disposed in the first section, and wherein the controller and the plurality of batteries are disposed in the second section.

22. The device of claim 21, wherein the plurality of batteries is configured to power the controller and the one or more heating elements continuously for a period of at least six to nine days.

23. The device of claim 20, wherein the plurality of batteries is configured to power the controller and the one or more heating elements continuously for an entirety of the time while the temperature-controlled device is being transported from the normal gravity environment to the space station in the micro-gravity environment.

24. The device of claim 20, wherein the predetermined temperature is in the range of 0° C. to 42° C.

25. The device of claim 20, wherein the predetermined temperature is 37° C.

26. The device of claim 20, wherein the one or more heating elements comprise a thermoelectric device.

27. The device of claim 20, wherein the one or more heating elements comprise a resistive heater.

28. The device of claim 20, wherein the plurality of batteries is configured to be charged at the space station.

29. The device of claim 28, wherein the plurality of batteries is configured to power the controller and the one or more heating elements for a majority of a time while the temperature-controlled device is being transported from the space station in the micro-gravity environment to the normal gravity environment.
